(19) United States
(12) Patent Application Publication
(10) Pub. No.: US 2006/0149771 A1
(43) Pub. Date: Jul. 6, 2006

(54) Information processing system and communication retry method

(75) Inventors: Gou Kojima, Yamato (JP); Tetsuo Tanaka, Yamato (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/290,508

(22) Filed: Dec. 1, 2005

(30) Foreign Application Priority Data
Jan. 5, 2005 (JP) 2005-000766

(51) Int. Cl. G06F 17/00

(52) U.S. Cl. 707/101

(57) ABSTRACT

To simplify the user's operation to obtain an HTML document. A relay apparatus 100 stores, when a communication log recording start request is given from a WWW browser 200, communication messages exchanged between the WWW browser 200 and a WWW server 300 in a data storage section 130 as communication logs until a communication log recording stop request is given from the WWW browser 200. An HTTP communication definition generating apparatus 400 analyzes the communication logs from the relay apparatus 100, and generates communication definition information for reproducing a request given from the WWW browser 200 to the WWW server 300. Further, an HTTP communication retry apparatus 500, when receiving a retry start request from the WWW browser 200, generates a series of requests to be given to the WWW server 300 based on the HTTP communication definition information, and sequentially sends the series of requests to the WWW server 300. The HTTP communication retry apparatus 500 then sends a response of the WWW server 300 relative to the last request of the series of requests back to the WWW browser 200.

### CLAIM OF PRIORITY

The present application claims priority from Japanese application P2005-000766 filed on Jan. 5, 2005, the content of which is hereby incorporated by reference into this application.

### FIELD OF THE INVENTION

The present invention relates to an access automation technology that allows a user to effectively use a WWW (World Wide Web) service requiring a plurality of request transmissions.

### BACKGROUND OF THE INVENTION

Described in Patent Document 1, Japanese Patent Publication Laid-Open No. 2000-76266, is an automatic execution system for recording/retrying an operation to a WWW browser (hereinafter referred to as a browser operation). This system is provided with a WWW proxy server that embeds a script (an event handler) for notifying the occurrence of a browser operation event into an HTML document of a WWW page in order to record the browser operation in the user's terminal side. A user causes the WWW browser to read an applet that records a browser operation event and downloads an HTML document of a WWW page via the WWW proxy server, and afterward the applet records the browser operation event the event handler embedded into the HTML document notifies.

However, the execution processing of the script embedded into the HTML document of the WWW page may vary in a different type and version of WWW browser on the user's terminal. Consequently, the browser operation event may not be recorded in accordance with the intention depending on the type and version of WWW browser.

To cope with this problem, the present invention has an object to allow the user to browse an intended WWW page with a simple operation regardless of the type and version of WWW browser.

### SUMMARY OF THE INVENTION

One aspect of the present invention is directed to an information processing system equipped with a plurality of information processing apparatuses, which comprises:

a first information processing apparatus of the plurality of information processing apparatuses having
a storage section in which communication logs are stored, and
a communication log generation section which, when a first request is given from a client, records communication messages exchanged between the client and a server as the communication logs in the storage section until a second request is given from the client; and

a second information processing apparatus of the plurality of information processing apparatuses.

In this aspect, the first information processing apparatus or the second information processing apparatus of the plurality of information processing apparatuses has a communication definition generation section for generating communication definition information to reproduce the request which is given to the server from the client and included in the communication logs recorded in the storage section during a period of time from the first request to the second request.

Further, in this information processing system, any of the first information processing apparatus, the second information processing apparatus or a third information processing apparatus of the plurality of information processing apparatuses may have a communication execution section which, when receiving a third request from the client, generates a series of requests to be given to the server based on the communication definition information, sequentially sends the series of requests to the server, and sends a response of the server relative to the last request of the series of requests to the client.

The aspect of the present invention allows a user to browse an intended WWW page with a simple operation regardless of the type and version of WWW browser.

### BRIEF DESCRIPTION OF THE DRAWINGS

Embodiments of the present invention will be described in detail based on the following figures, wherein:

FIG. 1 is a view showing the configuration of an HTTP communication retry system according to an embodiment of the present invention;

FIG. 2 is a flowchart of a communication log record processing according to the embodiment of the present invention;

FIG. 3 is a view showing the data structure of a communication log table according to the embodiment of the present invention;

FIG. 4 is a view showing a description example of HTTP communication definition information according to the embodiment of the present invention;

FIG. 5 is a view showing a description example of bookmark information according to the embodiment of the present invention;

FIG. 6 is a flowchart of an HTTP communication definition generation processing according to the embodiment of the present invention; and

FIG. 7 is a flowchart of an HTTP communication retry processing according to the embodiment of the present invention.

### DESCRIPTION OF THE EMBODIMENT

Hereinafter, an embodiment according to the present invention will be described with reference to the accompanying drawings.

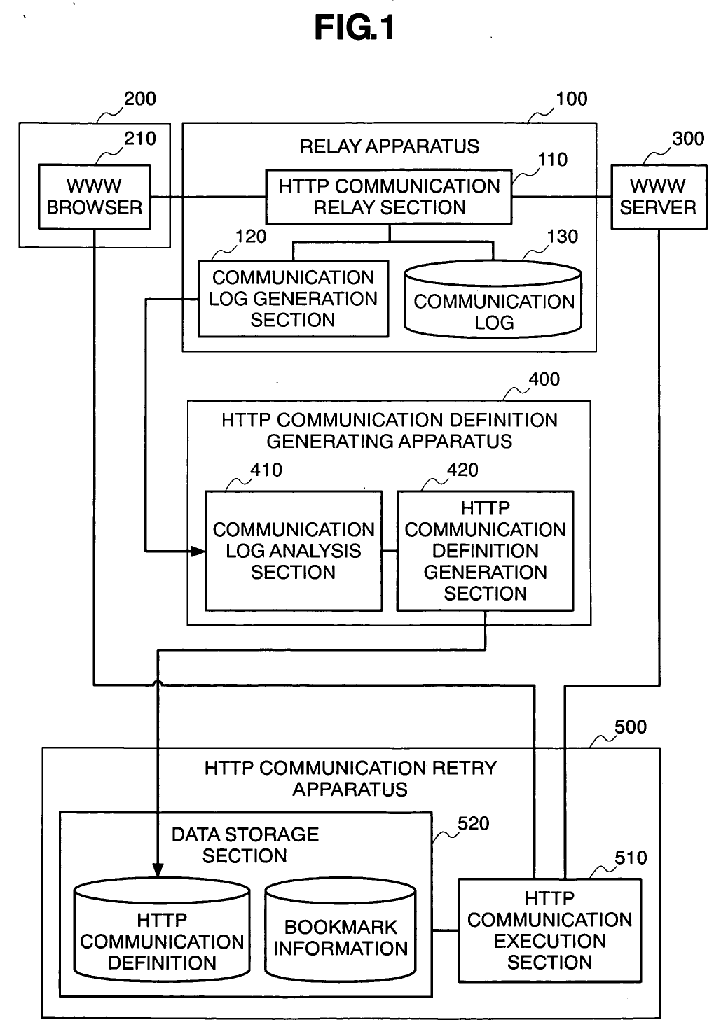

At first, the general configuration of a network system according to the present embodiment is described with reference to FIG. 1.

The network system according to the embodiment includes a plurality of information processing apparatuses 100, 200, 300, 400, 500 that are connected to a network.

These information processing apparatuses include: (1) one or more information processing apparatus(es) (hereinafter referred to as client terminal (s)) 200 in which a WWW browser 210 is installed; (2) an information processing apparatus (a WWW server) 300 for sending back an HTML document in response to a request from the WWW browser 210; (3) an information processing apparatus (hereinafter referred to as a relay apparatus) 100 for relaying communications between the client terminal(s) 200 and the WWW server 300, and recording logs of messages exchanged between the client terminal (s) 200 and the WWW server 300 (hereinafter referred to as communication logs); (4) an information processing apparatus (hereinafter referred to as an HTTP communication definition generating apparatus) 400 for generating HTTP communication definition information and the like used for reproducing a series of HTTP communication processings that were carried out between the WWW browser 210 and the WWW server 300 based on the communication logs; and (5) an information processing apparatus (hereinafter referred to as an HTTP communication retry apparatus) 500 for carrying out the series of HTTP communication processings defined in the HTTP communication definition information in response to a request from the WWW browser 210, and sending the resulting HTML document back to the WWW browser 210.

The information processing apparatuses 100, 200, 300, 400, 500 respectively have a normal hardware configuration (a hard disc with a CPU, a memory and programs installed therein and the like) that is required to execute programs for realizing each of the functions thereof.

Hereinafter, the functional configurations of each of the information processing apparatuses 100, 200, 300, 400 are described.

The relay apparatus 100 has an HTTP communication relay section 110 for relaying HTTP communications between the WWW browser 210 and the WWW server 300, a data storage section 130 in which communication logs between the WWW browser 210 and the WWW server 300 are stored, and a communication log generation section 120 for storing the communication logs in the data storage section 130 each time the HTTP communication relay section 110 relays an access from the WWW browser 210 to the WWW server 300. With such a functional configuration, the relay apparatus 100 accumulates the logs of a series of messages exchanged between the WWW browser 210 and the WWW server 300 in the communication log storage section 130 as the communication logs.

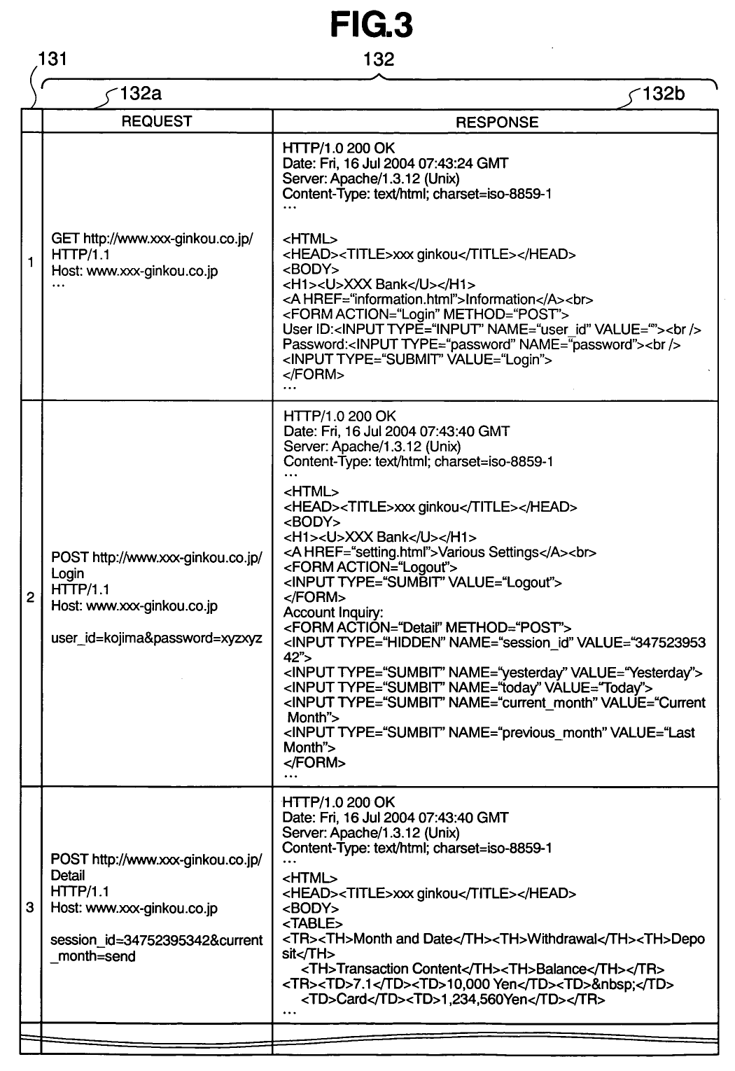

Herein, as shown in FIG. 3, the communication log stored in the data storage section 130 includes information corresponding to a message log 132 and a sequence number 131. Each message log 132 includes a request message 132a from the WWW browser 210 to the WWW server and a response message 132b to the request message. Incidentally, as an example of the communication logs, FIG. 3 shows communication logs relating to a series of message exchanges carried out between the WWW server and the WWW browser 210 for receiving a bank account inquiry service the WWW server provides.

The HTTP communication definition generating apparatus 400 has a communication log analysis section 410 for analyzing communication logs in response to an instruction of the relay apparatus 100 and a communication definition generation section 420 for generating HTTP communication definition information and bookmark information based on the analysis result by the communication log analysis section 410. With such a functional configuration, the HTTP communication definition generating apparatus 400 extracts parameters required to reproduce a series of HTTP communication processings that were carried out between the WWW server 300 and the WWW browser 210, and generates HTTP communication definition information including the resulting parameter.

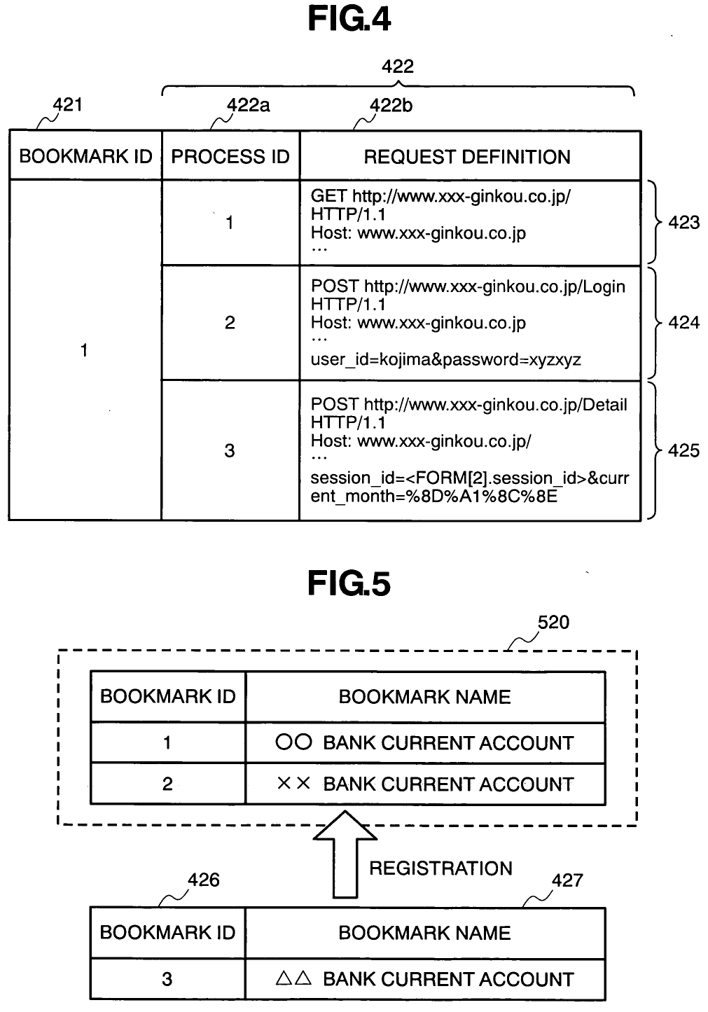

The HTTP communication definition information generated herein includes, as shown in FIG. 4, identification information of HTTP communication processings to be reproduced (hereinafter referred to as a bookmark ID) 421 and a series of requests containing information 422 used for reproducing the HTTP communication processings. Each piece of request information includes a request definition 422b and identification information of the request definition (hereinafter referred to as a process ID). The bookmark information includes, as shown in FIG. 5, a bookmark ID 426 included in the corresponding HTTP communication definition information and a bookmark name 427 associated with this bookmark ID. Incidentally, the bookmark information in which the bookmark name is associated with the bookmark ID is generated separately from the HTTP communication definition information herein, however, it is not necessarily to do so, if the bookmark name is included in the HTTP communication definition information.

The HTTP communication retry apparatus 500 has a data storage section 520 in which the HTTP communication definition information and bookmark information obtained from the HTTP communication definition generating apparatus 400, and a communication execution section 510 for executing HTTP communications with the WWW server 300 based on the HTTP communication definition information and bookmark information in the data storage section 520. Incidentally, the data storage section 520 is provided with a communication definition information control table in which the HTTP communication definition information is registered and a bookmark information control table in which the bookmark information is stored.

With such a functional configuration, the communication retry apparatus 500 reproduces a series of HTTP communication processings having been carried out between the WWW browser 210 and the WWW server 300 in the past, based on the HTTP communication definition information in response to a retry request from the WWW browser 210, and sends the resulting HTML document back to the WWW browser 210. In other words, the user of the client terminal 200 can cause a WWW page to be displayed with one browser operation of sending the retry request as long as the WWW page has been once displayed.

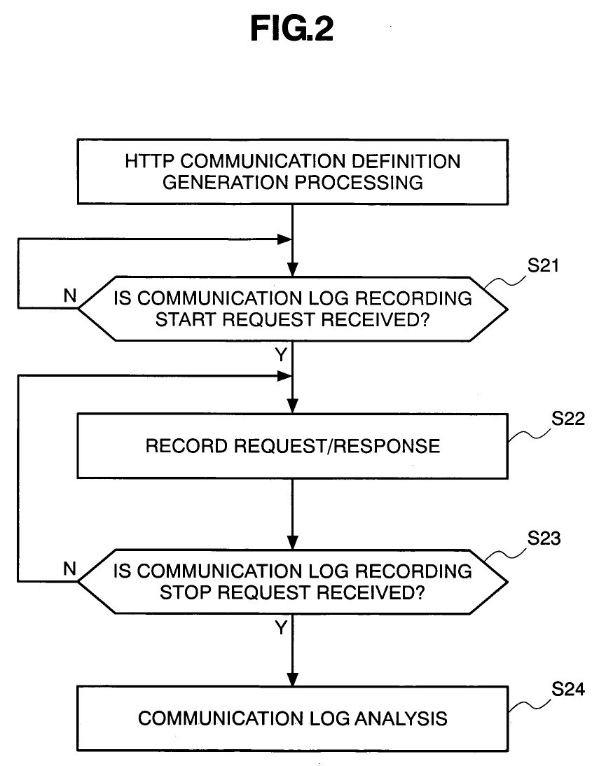

Next, a communication log record processing the relay apparatus 100 of FIG. 1 carries out is described with reference to FIG. 2.

The WWW browser 210 on the client terminal 200 sends an HTTP log recording start request to the relay apparatus in response to a user's instruction (S21), and then the relay apparatus 100 carries out the following processing in response to the HTTP recording start request. In other words, the communication log generation section 120 stores the request 132a from the WWW browser 210 to the WWW server 300 and the response 132b to the request in the data storage section 130 by associating them with the sequence number 131, each time the communication relay section 110 relays an access from WWW browser 210 to the WWW server 300 (S22).

Herein, when the WWW browser 210 sends a log recording stop request to the relay apparatus 100 in response to a user's instruction (S23), the communication log generation section 120 stops the communication log recording, and sends a communication definition generation request including a series of communication logs that are registered in the communication log table of the data storage section 130 to the communication definition generating apparatus 400 (S24).

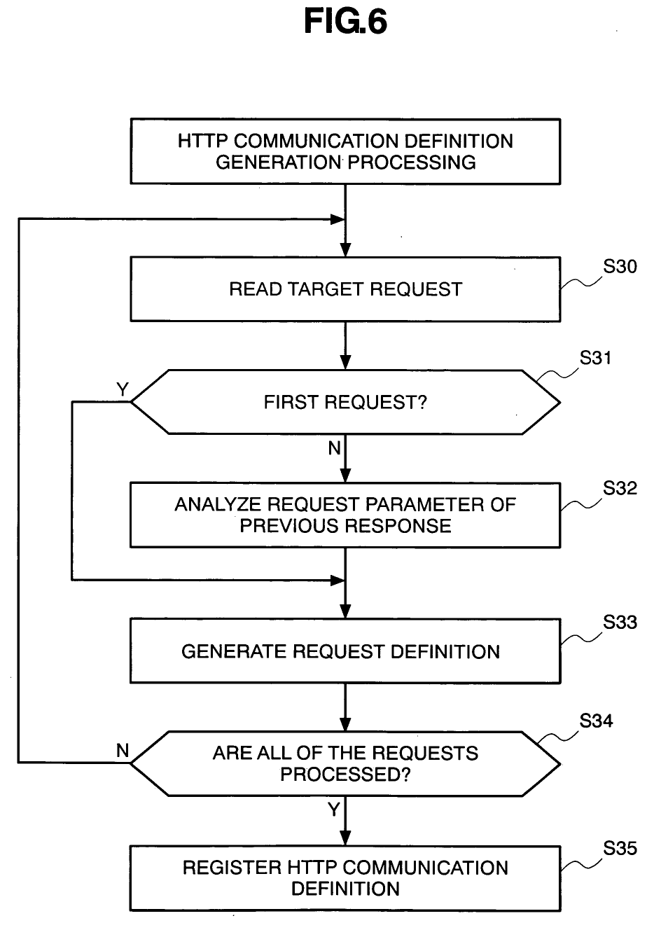

Next, a communication definition generation processing the HTTP communication definition generating apparatus 400 that received the communication definition generation request from the relay apparatus 100 carries out is described with reference to FIG. 6. It takes, as an example, the case in which the series of communication logs shown in FIG. 3 are included in the communication definition generation request.

The communication log analysis section 410 extracts the request message 132a in ascending order of the sequence number 131 among the communication logs included in the communication definition generation request, and sets the request message 132a as a process target request (S30). Further, the communication log analysis section 410 determines whether the process target request is the first request message of the series of request messages, in other words, whether the sequence number 131 associated with the process target request is “1” or not (S31)

If the result is that the process target request is the first message (in other words, the sequence number 131 is “1”), the communication log analysis section 410 carries out again S33 and the successive processings.

On the other hand, if the process target request is not the first request, the communication log analysis section 410 extracts parameters related to the process target request from the response message associated with the sequence number 131 smaller than the sequence number 131 of the process target request by 1, in other words, from the response message immediately preceding the process target request (hereinafter referred to as the previous response) as described below, and analyzes the extracted parameters (S32).

At first, the communication log analysis section 410 searches elements generating the process target request in the previous response. For example, when the method of the process target request is “POST”, the communication log analysis section 410 searches the FORM element in the previous response, and when the method of the process target request is “GET”, it searches the A element and the FORM element.

For example, when the request message with the sequence number “2” 131 is the process target request, the method of the process target request is “POST” and its URL is “http://www.xxx-ginkou.co.jp/Login”, so that the communication log analysis section 410 searches the FORM element in which the absolute pass “http://www.xxx-ginkou.co.jp/Login” or the relative pass “Login” is specified as the ACTION attribute value (the FORM element in the sixth line counting from the tag <HTML>) from the response message with the sequence number “1” 131 (previous response).

The communication log analysis section 410 then checks whether the parameter names and their values that should be used in the definition for retying the process target request are included in the A element or FORM element found by the search of the previous response. More particularly, the communication log analysis section 410 checks whether the NAME attribute values and VALUE attribute values of the INPUT elements, or the arguments of the request destination URL (for example, the argument name “a” and value “x”, argument name “b” and value “y” in “(URL)?a=x&b=y”) are included therein.

If the result is that the parameter names and their values that should be used for the request definition, more particularly, the NAME attribute values and VALUE attribute values of the INPUT elements or the argument names and their values of the request destination URL are included therein, the communication log analysis section 410 extracts them as the parameter names and their values to be used for the request definition.

For example, when the request message with the sequence number “2” is the process target request, the communication log analysis section 410 extracts NAME attribute values and VALUE attribute values from the child elements (INPUT elements) of the FORM elements of the response message (previous response) with the sequence number “1”. More particularly, the communication log analysis section 410 extracts the NAME attribute value “user_id” and the VALUE attribute value “”, the NAME attribute value “password” and the VALUE attribute value “” from the INPUT elements in the seventh and eighth lines counting from the tag <HTML> respectively.

Further, when the request message with the sequence number “3” is the process target request, the communication log analysis section 410 extracts NAME attribute values and VALUE attribute values from the child elements (INPUT elements) of the FORM elements of the response message (previous message) with the sequence number “2”. More particularly, it extracts the NAME attribute value “session_id” and the VALUE attribute value “34752395342” from the child element (INPUT element) of the FORM element in eleventh line counting from the <HTML> tag.

The communication log analysis section 410 then compares the parameter names and values extracted from the previous response at this time with the parameter names and values of the process target request. As a result, if neither of the parameter names or values are identical to the parameter names and values of the process target request, the communication log analysis section 410 determines that the parameters that should be used for the request definition are not included in the previous response, and sets the parameter names and values used in the process target request as they are to the parameter names and values to be used for the request definition. On the other hand, if any of the parameter names and values are identical to the parameter name and value of the process target request, the communication log analysis section 410 maintains them as the parameter name and value to be used for the request definition.

For example, when the request message with the sequence number “3” is the process target request, the communication log analysis section 410 compares the NAME attribute value “session_id” and the VALUE attribute value “34752395342” with the parameter name and value of the process target request (session_id and 34752395342). As a result, the parameter name and value extracted from the previous response and the parameter name and value of the process target request are identical to each other, so that the communication log analysis section 410 maintains the parameter name session_id and the description indicting the VALUE attribute value of the previous response as the parameter name and value to be used for the request definition. Incidentally, when a parameter with no equivalent value exists, the communication log analysis section 410 maintains the parameter value currently being used in the process target request as the parameter value to be used for the request definition.

When the above parameter analysis processing is completed, the HTTP communication definition generation section 420 generates a request definition based on its analysis result and the process target request. More particularly, it generates the request definition by substituting the parameter value of the process target request with the maintained parameter value. Because of this feature, when the parameters of the process target request and the previous response differ from each other, the process target request is set to the request definition as it is, and when the parameters of the process target request and the previous response are common to each other, the parameter value obtained by substituting the parameter value of the process target request with the description indicating the parameter value of the previous response is set to the request definition. Further, the HTTP communication definition generation section 420 appends a process ID corresponding to the sequence number of the process target request to this request definition (S33).

For example, when the request message with the sequence number “3” is the process target request, a request definition 425 included in the HTTP communication definition information of FIG. 4 is generated, wherein a process ID “3” corresponding to the sequence number “3” of the process target request is appended to the request definition. In this request definition, the description “<FORM[2].session_id>” that represents the VALUE attribute value of the INPUT element having the NAME attribute value session_id in the second FORM element within the previous response is set as the value of parameter session_id, and the parameter value of the process target request is set as it is as the other parameter value.

As for the request messages for the sequence numbers “1” “2”, request definitions 423, 424 included in the HTTP communication definition information of FIG. 4 are generated, wherein process IDs “1” “2” are appended to the respective request definitions thereof. Incidentally, the parameter names and values of the request messages for the sequence numbers “1” “2” are used as they are in the request definitions 423, 424.

When having generated the request definitions for the process target request, the HTTP communication definition generation section 420 checks whether all of the request messages included in the HTTP communication definition generation request were set to the process target request (S34), and as a result, if no request message was set to the process target request, the HTTP communication definition generation section 420 carries out again S30 and the successive processings so as to set the next request message to the target message.

When having generated the request definitions for the requests of the series of message logs respectively as described above, the HTTP communication definition generation section 420 grants a bookmark ID to the series of request definitions. Because of this feature, as shown in FIG. 4, the HTTP communication definition information for reproducing the series of request messages, in other words, the HTTP communication definition information in which the series of HTTP communication processings carried out during a period of time from the log recording start instruction to the log recording stop instruction is generated.

Further, the communication definition generation section 420 sends an input request of a name to be granted to the bookmark ID, via the relay apparatus 100, to the client terminal 200 which is the source of the communication log recording start request. Herein, when the user inputs a name to be granted to the bookmark ID, in other words, a name to be granted to the series of HTTP communication processings the user himself/herself carried out, in the client terminal 200, and instructs the WWW browser 210 to transmit it, the HTTP communication definition generation section 420 receives the name via the relay apparatus 100 and generates bookmark information in which the name and the bookmark ID are associated with each other.

Finally, the communication definition generation section 420 sends the generated HTTP communication definition information and bookmark information to the HTTP communication retry apparatus 500. Because of this feature, the HTTP communication retry apparatus 500 registers the HTTP communication definition information and bookmark information from the HTTP communication definition generating apparatus 400 in the communication definition control table and bookmark information control table corresponding to the user (the client terminal 200 which is the source of the communication log recording start request) respectively (see FIG. 5).

As described above, with the communication definition generating processing according to the present embodiment, only by causing the WWW browser to send the communication log recording start request, the collection of communication logs and the generation of HTTP communication definition information are carried out in the relay apparatus and the HTTP communication definition generating apparatus. This makes it possible to prevent load on the WWW browser of the WWW client terminal. Further, there is no need to cause the WWW browser to execute the scripts for carrying out the collection of communication logs and the generation of HTTP communication definition information. This allows to collect communication logs as well as to generate HTTP communication definition information, regardless of the type and version of the user's WWW browser without fail.

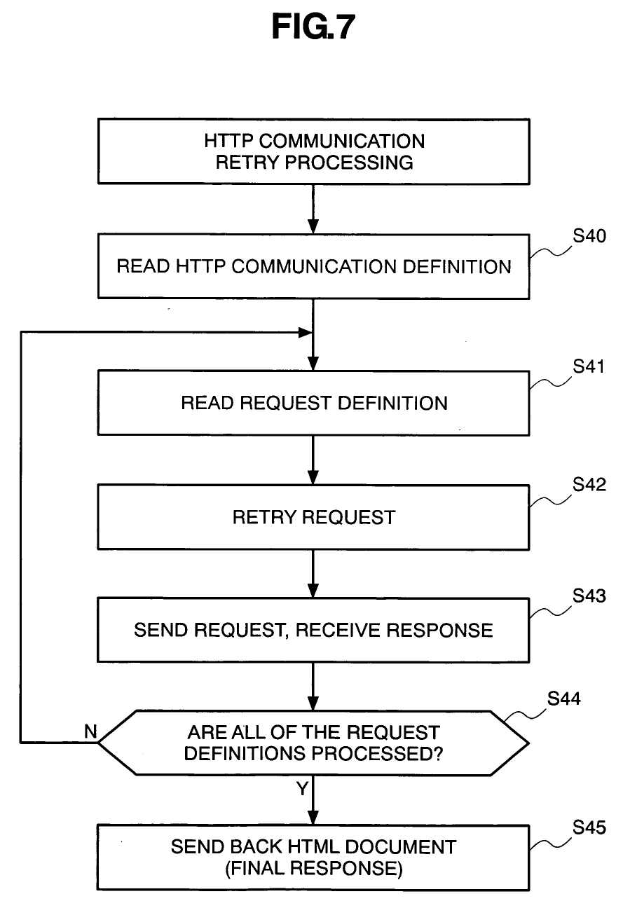

An HTTP communication retry processing the HTTP communication retry apparatus 500 of FIG. 1 carries out is described with reference to FIG. 7.

When the WWW browser 210 on the client terminal 200 sends a bookmark list transmission request to the HTTP communication retry apparatus 500 in response to a user's instruction, the HTTP communication retry apparatus 500 sends back the bookmark information control table corresponding to the user in accordance with this request. Because of this feature, the list of the bookmark IDs and bookmark names is displayed in a display of the client terminal 200. The WWW browser 210 sends the retry start request including any of the bookmark IDs included in the list to the HTTP communication retry apparatus 500, and the HTTP communication retry apparatus 500 carries out the following HTTP communication retry processing in accordance with the request.

The HTTP communication execution section 510 reads the HTTP communication definition information associated with the bookmark ID included in the retry start request from the communication definition information control table (S40).

The HTTP communication execution section 510 then extracts a request definition having the smallest process ID of the request definitions that are not set to the target request definition from the HTTP communication definition information as the target request definition (S41), and generates an HTTP request based on the request definition (S42).

For example, when the description using the parameter value of the previous response (for example, the request parameter “<FORM[2].session_id>” that is included in the request definition of the process ID “3” in FIG. 4) is included in the request definition, the HTTP communication execution section 510 extracts the corresponding parameter from the previous response, and generates a request including this parameter value as the request parameter. Because of this feature, the request that is made using the FORM element of the previous response with the parameter value containing a variable element (for example, an INPUT element) as a child element can be retried.

Further, the HTTP communication execution section 510 sends the generated HTTP request to the WWW server 300, and maintains the resulting response (S43). Subsequently, the HTTP communication execution section 510 determines whether retried HTTP requests from all of the request definitions included in the HTTP communication definition information having been read in S40 (S44).

If the result is that any request definition that is not retried remains, the HTTP communication execution section 510 carries out again S41 and the successive processings so as to retry the HTTP request with the request definition associated with the process ID larger than the process ID of the current target request definition by one as a new target request definition.

On the other hand, when having retried HTTP requests from all of the request definitions, the HTTP communication execution section 510 sends back a response (HTML document) relative to the last HTTP request to the WWW browser 210 which is the retry start request source (S45). Because of this feature, the user can refer to the desired information (WWW page the HTML document represents).

With the HTTP communication retry processing according to the present embodiment, the HTTP communication retry apparatus reproduces the past HTTP communication processings between the WWW client terminal and the WWW server based on the HTTP communication definition information in response to the request from the WWW client terminal and sends the finally obtained HTML document to the WWW client terminal, so that the user can obtain the HTML document, which was obtained by carrying out a plurality of browser operations (link clicks, button clicks and the like) in the past, by only carrying out the operation of sending the retry start request to the HTTP communication retry apparatus. Thus, the user can browse the frequently browsing WWW pages, such as, for example, the account pages at the bank site and the product pages at the auction site with a simple operation.

Herein, the user only causes the WWW browser of the WWW client terminal to send a request for the HTTP communication retry apparatus to start the HTTP communication retry processing, thereby allowing to prevent load on the WWW browser of the WWW client. Also, there is no need to cause the WWW browser to execute specific scripts, so that the difference in the type and version of the WWW browser hardly affects the operation.

In the above description, the system configuration in which one WWW client terminal 200 and one WWW server 300 included was exemplified, but a plurality of WWW client terminals and a plurality of WWW servers may be included in the network system according to the present embodiment. For example, in a case in which a plurality of WWW client terminals are included therein, the communication logs and HTTP communication definition information need to be controlled for each user. Thus, for example, it is necessary to carry out a user authentication processing to register the communication logs and HTTP communication definition information by associating with the user identification information obtained as described above.

Further, the relay apparatus, the communication definition generating apparatus and the communication retry apparatus are realized in the separate information processing apparatuses respectively, however, of these three apparatuses, the relay apparatus, communication definition generating apparatus and communication retry apparatus, the functions of at least two apparatuses may be implemented on one information processing apparatus. In this case, the functions the above described functional configuration achieves can be achieved by an arithmetic processing section that is realized by the programs and hardware configuration (a PCU, a memory, a hard disc and the like) that are installed in one information processing apparatus. It is to be noted herein that the information processing apparatus in which these functions should be implemented is not limited to a specific information processing apparatus on the network.

For example, the functions of the relay apparatus, communication definition generating apparatus and communication retry apparatus may be implemented on a client terminal. In this case, the client terminal controls the own communication logs and HTTP communication definition information, so that it is not necessary to control the communication logs and the HTTP communication definition information on the network. Thus, the user control and security control are facilitated.

Also, the functions of the relay apparatus, communication definition generating apparatus and communication retry apparatus may be implemented on the WWW server 300 that provides services for a plurality of client terminals. In this case, the WWW server 300 needs to control the communication logs and HTTP communication definition information for each user. Thus, the WWW server 300, for example, needs to register the communication logs and the HTTP communication definition information by associating with the user identification information obtained by the user authentication processing as described above. Herein, in a case in which the WWW server provides separate services for each user, the identification information the user uses in the services may be used as the identification information to be associated with the communication logs and HTTP communication definition information.

Having described a preferred embodiment of the invention with reference to the accompanying drawings, it is to be understood that the invention is not limited to the embodiment and that various changes and modifications could be effected therein by one skilled in the art without departing from the spirit or scope of the invention as defined in the appended claims.

What is claimed is:

1. An information processing system equipped with a plurality of information processing apparatuses, comprising:
a first information processing apparatus of the plurality of information processing apparatuses having
a storage section in which communication logs are stored, and
a communication log generation section which, when a first request is given from a client, records communication messages exchanged between the client and a server as the communication logs in the storage section until a second request is given from the client; and
a second information processing apparatus of the plurality of information processing apparatuses,
wherein
the first information processing apparatus or the second information processing apparatus has a communication definition generation section for generating communication definition information to reproduce a request, which is given from the client to the server and included in the communication logs recorded in the storage section, during a period of time from the first request to the second request.

2. The information processing system according to claim 1,
wherein the communication definition generation section, of the communication logs which:
when a first parameter of the request given from the client to the server and a second parameter of an element that has generated the request and is included in a response given from the server to the client before the response differ from each other, sets the request as the request definition, and
when the first parameter and the second parameter are common to each other, generates the request definition in which the description indicating the second parameter value is set to the first parameter value of the request.

3. The information processing system according to claim 1,
wherein
any of the first information processing apparatus, the second information processing apparatus or a third information processing apparatus of the plurality of information processing apparatuses comprises a communication execution section which, when receiving a third request from the client, generates a series of requests to be given to the server based on the communication definition information, sequentially sends the series of requests to the server, and sends a response of the server relative to the last request of the series of requests to the client.

4. The information processing system according to claim 2,
wherein
any of the first information processing apparatus, the second information processing apparatus or a third information processing apparatus of the plurality of information processing apparatuses comprises a communication execution section which, when receiving a third request from the client, generates a series of requests to be given to the server based on the communication definition information, sequentially sends the series of requests to the server, and sends a response of the server relative to the last request of the series of requests to the client.

5. A program of causing an information processing apparatus to function as the following sections, comprising:
a communication log analysis section for extracting, from communications including a series of communication messages exchanged between a client and a server, a first parameter of a request given to the server from the client and a second parameter of an element that has generated the request and is included in a response given from the server to the client before the response, maintaining the first parameter when the first parameter value and the second parameter value differ from each other, and maintaining the description indicating the second parameter when the first parameter value and the second parameter value are identical to each other; and
a communication definition generation section for generating a request definition in which the value the communication log analysis section maintains is set as the parameter value corresponding to the value.

6. A program of causing an information processing apparatus having a storage section in which communication definition information including a series of requests to be sent to a server is stored, the communication definition information being associated with bookmark IDs, and an arithmetic processing section, to carry out:
a processing in which the arithmetic processing section, when receiving a third request including a bookmark ID from a client, reads the communication definition information associated with the bookmark ID from the storage section, sends the first request of a series of requests included in the communication definition information to the server, and sequentially sends the remaining requests of the series of requests to the server each time receiving a response from the server; and
a processing in which the arithmetic processing section sends a response of the server relative to the last request of the series of requests to the client.

7. A communication retry method that is executed in an information processing system equipped with a plurality information processing apparatuses, in which a first communication processing apparatus of the plurality of information processing apparatuses has a storage section for storing communication logs, the method comprising:
a step wherein the first information processing apparatus, when a first request is given from the client, records communication messages exchanged between the client and the server as the communication logs in the storage section until a second request is given from the client;
a step wherein the first information processing apparatus or a second information processing apparatus of the plurality of information processing apparatuses generates communication definition information for reproducing a series of requests that are given from the client to the server and included in the communication logs recorded in the storage section during a period of time from the first request to the second request; and
a step wherein any of the first information processing apparatus, the second information processing apparatus and a third information processing apparatus of the plurality of information processing apparatuses generates a series of requests to be given to the server when receiving a third request from the client, sequentially sends the series of requests to the server, and sends a response of the server relative to the last request of the series of requests to the client.
